(19) United States
(12) Patent Application Publication
(10) Pub. No.: US 2013/0325637 A1
(43) Pub. Date: Dec. 5, 2013

(54) SYSTEM AND METHOD FOR CONDUCTING MARKETING AND COMMERCE

(71) Applicant: Hubin Jiang, Great Falls, VA (US)

(72) Inventor: Hubin Jiang, Great Falls, VA (US)

(21) Appl. No.: 13/842,794

(22) Filed: Mar. 15, 2013

Related U.S. Application Data
(60) Provisional application No. 61/655,816, filed on Jun. 5, 2012.

(51) Int. Cl. G06Q 30/02

(52) U.S. Cl. CPC G06Q 30/0276
USPC 705/14.72

(57) ABSTRACT

A method for conducting chain reaction marketing and commerce. The method includes the steps of registering content and a product, conducting chain reaction marketing and conducting online commerce, the step of conducting online commerce including obtaining a source of content, the content containing registered product objects and a chain hanger, specifying a product object from the content that contains the product that a user wants to purchase, processing information about the user, the content, and the product object, retrieving product purchasing information; and completing a purchase transaction.

### RELATED APPLICATIONS

This application claims the benefit of U.S. Provisional Application Ser. No. 61/655,816, filed on Jun. 5, 2012, the contents of which are hereby incorporated by reference in their entirety.

### FIELD

This document relates to an online system for chain reaction marketing and commerce.

### BACKGROUND

Sales and marketing of products and services have traditionally been led by manufacturers and service providers who in turn employ a variety of media. E-commerce, online stores, website, social media, social networking, product referral programs, etc. also play important roles in the sales and marketing of products and services.

As may be appreciated, the purpose of marketing is to promote product or service awareness in order to maximize sales. Due to the increased variety of marketing venues, which increase the number of ways to market a product, marketing budgets have increased in an effort to ensure penetration, while targeting the appropriate audiences.

Of course, product sales are realized in many ways. Most products can be sold electronically online. Sales programs such as product or service referral programs have been established for those who want to sell products or services or for those who just want to relay product or service information in order to assist in the marketing of products or services. Referral programs often are incentivized by providing financial benefits for the referrer. However, to set up an e-store or product relay station, not only are technical assistance and programming efforts required but also sale efforts. Although today's technologies intend to make the efforts minimal, users without sufficient technological background face a burden in setup and maintenance. Further, due to the efforts involved, neither referral nor relay provide for effective product or service marketing for manufacturers or service providers.

### SUMMARY

Content, as used herein, is defined as a portion of, or a complete document, or a combination of different portions of a document, or several documents, or several complete documents, in any format, such as, but not limited to, web logs (blogs, or forum, etc.), pictures, images, XML content, HTML content, any electronic documents, any electronic content, files, web content, etc. Content, as used herein, may also be defined as, by way of example, but not of limitation, object(s) in content format, character(s), word(s), statement(s), or paragraph(s), voice, other media, picture(s), image(s), portion(s) of a picture or image, any combination or portion thereof, etc. Therefore, content and object(s) will be used interchangeably whenever and wherever a description can be made more clearly. Content can be authored by any possible means (manually, or automatically, by human or by machine, etc., or obtained from any source, or created or specified in any way).

In one aspect, provided is a method and system that resolves marketing and sales challenges by allowing anyone to promote a product or service (collectively hereinafter referred to as “Product” or “product”) by registering content, establishing an e-store for the content's registrant, and allowing anyone to purchasing Product anywhere from such content through the performance of tasks, such as, but not limited to, reading, commenting, studying, etc. A registrant can be the author of the content or whoever registered the content. Registrant's rights to register a content can be implemented with different policies.

In another aspect, provided is a method and system that allows anyone to market and/or purchase Product while creating content or performing any operation on content, whether or not created by a performer, including reading, commenting, studying, etc. Anyone can use the tools provided to select content and register it into the system provided herein, and therefore associate the content as a Product Object with a Product or Products. Such Product Object is then ready for chain reaction marketing and e-commerce. As such, anyone can market a product from anywhere. The method and system can integrate algorithms by way of example, but not of limitation, text mining, pattern recognition, object recognition, etc., or combinations thereof, in the way that the content selection and registration, product selection and registration, and content-product association can be realized by machine automation.

In one form, the method and system disclosed herein provides Product credibility verification and validation, e-commerce, Product trust ratings, etc. and functions transparently and seamlessly. As may be appreciated, although the marketing mode described may be manufacturer driven, it is mainly customer-driven and represents customer-driven, targeted marketing. It is effective and financially efficient.

In another aspect, provided is a method and system that establishes an e-commerce store for a person, without requiring that person's technical, programming, or administrative efforts. All that is required is to associate Product Objects in content by using tools provided by the system, although such an association can be made automatically as described herein. The Product is promoted by the content, and travels with content. The content is the media that promotes product(s), one's e-store and e-commerce.

In one form, Product is spread widely, rapidly, and globally through content sharing, commenting on content, and social networking.

In yet another aspect, provided is an algorithm that makes any comment to the content heritage of all the Product Objects contained in the content and the newly referred or related or derived content also becomes a Product carrier, which can be commented by another commenter. Anyone who comments on a content that contains a Product Object is also establishing an e-store for that person, transparently and seamlessly. Such a chain reaction of marketing spreads information and Product sales at a tremendous speed, and makes e-commerce sales occur anywhere.

In still yet another form, there is no need to go to an e-store in order to find a Product. A buyer can just search for content and order the Product from the content in which the Product appears. All Product information and price comparisons will be loaded from the system provided, which collects all information from registered manufacturers and Product vendors.

In a further form, provided is a context-aware marketing and commerce system, wherein a person involved in a content discussion or a person who bought Product in related content may be notified of new deals or news about the Product.

In one aspect, provided is a method and system of product registration. The method includes the steps of creating or obtaining content from a source of content; specifying an object in the content, the object selected from one or more characters, one or more statements, one or more paragraphs, one or more pictures, one or more images, one or more voices, one or more other kind of media, or combinations or portions thereof; determining whether the content was previously registered in the system; if the content was not previously registered, creating a new chain hanger that is related to the user and the content and generating a unique content source IDS; if the content was previously registered, retrieving existing and corresponding chain hangers using information including, but not limited to, user information and content information; for newly created content having parent content, assigning the content source IDS of the parent content to a parent content IDS of the chain hanger for newly created content having parent content, or assigning a value of NULL to the parent content IDS of the chain hanger should no parent content exist; and recording the authors of the content as originators of the chain hanger.

In another aspect, provided is a process for chain reaction marketing and sales. The process includes the steps of obtaining a source of content, the content containing registered product objects and a chain hanger; retrieving a content source IDS from the chain hanger of the content; providing and associating comments with the content; verifying if the comment correlates with parent content or with a product object in the parent content stored in the parent content's chain hanger although a product object can be stored anywhere that is appropriate for a specific implementation and if there is a correlation, then a new chain hanger is created and related to the commenter and the comments, which form new content; and updating a list of content properties of the new chain hanger. The correlation is made by content matching and mapping techniques, and can also be made by using other existing technologies such as, but not limited to, text matching, fuzzy matching, pattern recognition, voice/speech processing and recognition, content understanding, context awareness, data/text/object mining, etc., or combinations thereof.

In yet another aspect, provided is a process for conducting online commerce. The process includes the steps of obtaining a source of content, the content containing registered product objects and a chain hanger; specifying a product object from the content that contains the product that a user wants to purchase; processing information about the user, the content, and the product object; retrieving product purchasing information; and completing a purchase transaction.

In a further aspect, provided is a method for conducting chain reaction marketing and commerce. The method includes the steps of registering a product; conducting chain reaction marketing; and conducting online commerce, said step of conducting online commerce including obtaining a source of content, the content containing registered product objects and a chain hanger; specifying a product object from the content that contains the product that a user wants to purchase; processing information about the user, the content, and the product object; retrieving product purchasing information; and completing a purchase transaction.

These and other features will be apparent from the detailed description taken with reference to the accompanying drawings.

### BRIEF DESCRIPTION OF THE DRAWING

Further explanation may be achieved by reference to the description that follows and the drawing illustrating, by way of a non-limiting example, wherein:

FIG. 1 illustrates various operational modes of the system 100 disclosed herein;

FIG. 2 presents the three major tools for providing the services of the system disclosed herein;

FIG. 3 illustrates a structure of a chain hanger, in accordance herewith;

FIG. 4 illustrates a system that provides functions and tools to enable marketing and commerce, in accordance herewith;

FIG. 5 illustrates one form of a process of Content and Product registration, in accordance herewith;

FIG. 6 illustrates another form of a method of Content and Product registration, in accordance herewith;

FIG. 7 illustrates one form of a process for chain reaction marketing and sales, in accordance herewith;

FIG. 8 illustrates another form of a method for chain reaction marketing and sales, in accordance herewith; and

FIG. 9 a process for conducting commerce anywhere will be described.

### DETAILED DESCRIPTION

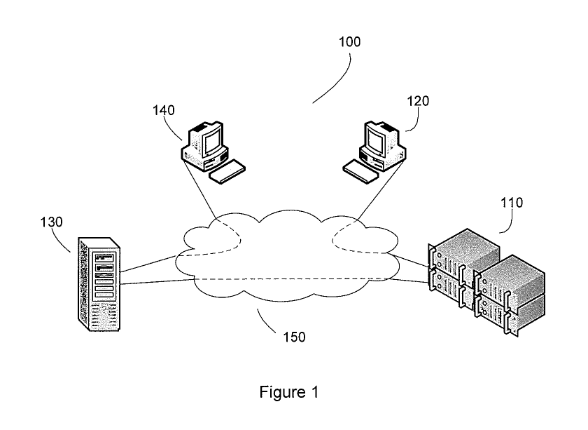

Various aspects will now be described with reference to specific forms selected for purposes of illustration. It will be appreciated that the spirit and scope of the systems and methods disclosed herein are not limited to the selected forms. Moreover, it is to be noted that the figure provided herein is not drawn to any particular proportion or scale, and that many variations can be made to the illustrated forms. Reference is now made to FIGS. 1-9.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise.

Each of the following terms: “includes,” “including,” “has,” “having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

It is to be understood that the various forms disclosed herein are not limited in their application to the details of the order or sequence, and number, of steps or procedures, and sub-steps or sub-procedures, of operation or implementation of forms of the methods or to the details of type, arrangement, and order of steps set forth in the following illustrative description and examples, unless otherwise specifically stated herein. The systems and methods disclosed herein can be practiced or implemented according to various other alternative forms and in various other alternative ways.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

### DEFINITIONS

A. General:

By N→n is meant that N has a property n.

By N•n is meant that n is the component or element of N.

By N=n is meant that n is the value of N.

By |N| is meant the value of n or original content of n.

By ∥N∥ is meant the total number of elements in set N.

By N•→n is meant that N points to n.

B. Content:

T is defined as a set consisting of any kind of text, P is a set consisting of any kind of picture, I is a set consisting of any kind of image, V is a set consisting of any kind of voice, M is a set consisting of any kind of other media that can express any meaning, and C is a set of content formed with quintuple {T, P, I, V, M}. In other words, C={c₁, c₂, . . . , cᵢ, . . . } where cᵢ is any content in the C and cᵢ can be any combination or construction of component of T, P, I, V, and M.

For descriptive convenience, cᵢ is also referred to as “Content”. Content can include, but is not limited to, an article, web log (Bbog, forum, or other forms), web content, XML, HTML, picture, image, voice, media, and any other type of document.

By c^{p}ᵢⱼ is meant that cᵢ is the Parent Content of cⱼ if cⱼ is derived from, or based on, commented to cᵢ. Vice versa, c^{c}ⱼᵢ means that cⱼ is the Child Content of cᵢ if cⱼ is derived from, or based on, commented to cᵢ.

C. Content Properties:

Content ID, cid is a property of Content, cᵢ. It uniquely identifies Content, and is symbolized as cᵢ→cid.

Parent Content IDS, CIDS^{p} is a property set of a Content, cᵢ. It contains all Content IDs which point to Contents that cᵢ refers to. CIDS^{p}={cid₁, cid₂, cidᵢ . . . }. CIDS^{p} can be empty. If CIDS^{p} is empty, then cᵢ is a root Content. It is created without referring other Contents. The Parent Content IDS is symbolized as cᵢ→CIDS^{p}.

A Content Originator is a representative who is responsible for the creation of Content. Content may be created by a person, a machine, or other entities.

Originator IDS, OIDS is a property set of a Content, cᵢ. It contains Content's all Content Originators' IDs, which point to all the Content Originators. OIDS={oid₁, oid₂, oidᵢ . . . }. OIDS contains at least one Content Originator, and is symbolized as cᵢ→OIDS.

Product Object, poᵢ, is defined to be a specified object in content cᵢ, which is successfully registered in system. Therefore, poᵢ is any part of or equal to cᵢ. Product object, poᵢ, includes, but is not limited to, character(s), word(s), statement, picture, image, portion of a picture or image, any object in content, or any combination thereof. The Product Object may also be content.

Product Objects, POS, is a property set of Content, cᵢ. It contains all Product Objects of cᵢ. POS={po₁, po₂, poᵢ . . . }. POS contains at least one Product Object unless the Content is registered in the system, without being associated with any product. It is symbolized as cᵢ→POS.

D. Product Object Properties:

Product Object ID, poid, is a property of a Product Object, poᵢ. It uniquely identifies a Product Object, and is symbolized as cᵢ→POS•po₁→poid.

Residential Information, r_{info}, is a property of a Product Object, poᵢ. It uniquely contains information for the value of poᵢ that is sufficient to locate the poᵢ in cᵢ. The information include the location of poᵢ in cᵢ, or other information. It is symbolized as cᵢ→POS•poⱼ→rinfo.

Product ID, pid, is a property of a Product Object, poᵢ. It points to a product associated with poᵢ, and is symbolized as cᵢ→POS•poⱼ→pid.

Product Register is a representative who is responsible for the registration of a Product. A Product may be registered by a person, a machine, or other entities. Registering a Product may be based on competition or the co-existence or other format regarding the same Content and same Project Object in the Content. If the registration is competition based, the first successful register will be the registrant of a Product in a Product Object of Content. Note, a registrant may not necessarily be the originator of Content. In other words, a Register may register a Product of a Product Object in a Content created by a different Originator who did not register the Product of the Product Object. However, the system can be implemented differently with different policies.

Product Register ID, rid is the unique ID pointing to a Product Register.

Product Register RIDS is a property set of a Product Object, poᵢ. It contains all Product Register IDs of poᵢ who registered poᵢ jointly. RIDS={rid₁, rid₂, ridᵢ . . . }. RIDS contains at least one Product Register. It is symbolized as cᵢ→POS•poⱼ→RIDS*ridₗ.

Referring now to FIG. 1 various operational modes of system 100 disclosed herein are shown. In operation, system 100 is loaded in and operating on server(s) 110. Client computers 120 are directly registered under and working with servers 110 so that they may receive services directly from servers 110, using software provided by system 100 and residing on servers 110. Server 130 is a foreign server, which provides its clients 140 with different services from servers 110. All the connections are completed though network 150, which may be, but is not limited to, local area networks, global networks, internet, wireless, etc., as those skilled in the art will plainly recognize. System 100 may also be configured to interface and operate with any and all forms of mobile and wireless devices and environments, cloud computing devices and environments, and devices and environment where data and information are processed electronically. As such, client computers 120 and 140 are not limited to computers (as schematically depicted) but are also deemed to include any and all forms of mobile and wireless devices and environments, as those skilled in the art would plainly recognize.

After server 130 registers with server 110, and the service requested is approved by server 110, all clients 140 that are registered or connected with server 130 will be able to utilize services from servers 110 through server 130. Clients, no matter whether they are clients 120 or clients 140, can use services provided by servers 110 by either using software provided by servers 110 or using their existing software which allows software tools from servers 110 to collaborate with them. The mode under which a client uses software directly provided by servers 110 is called Native Operation Mode (NOM), while the mode under which a client uses its existing software with tools from servers 110 is called Foreign Operation Mode (FOM).

However, no matter which operating mode is used, the system and methodology are the same; the only difference is the implementation configuration. With today's programming technology, server 110 can support two modes simultaneously and seamlessly.

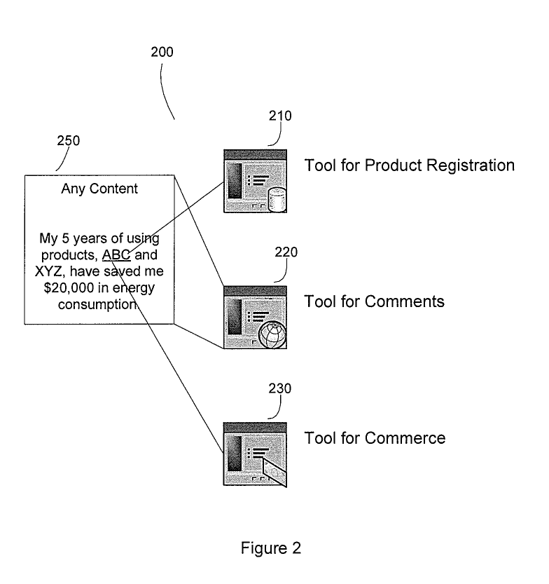

Referring now to FIG. 2, three major tools for providing services are depicted. These include a Tool for Product Registration 210, a Tool for Comments 220, and a Tool for Commerce 230. System 100 provides its services through content, whether operating in Native Operation Mode or Foreign Operation Mode, such content being in the form of, not limited to, a web page, a web log (blog, forum, or other forms), social media, a picture, an image, XML content, HTML content, or other electronic document content or files. Applying any of the three tools to any content will enable the performance of functions on the content, such as Product marketing and sales, Product e-commerce, and Product Purchasing. The functions of the three tools will now be described with respect to content 250.

As an example, assume that content 250 is blog content from social media, wherein a person, User A, wishes to express his experiences with respect to products ABC and XYZ. Assume, also, that he wants to promote product ABC and gain benefit such as financial benefits like commissions and money-back, coupon, reputation, participating some activities, etc. whenever a purchase of product ABC occurs as a result of and from his content and from those content which are derived from his content. Derived content occurs when a further comment on User A's content is posted from a web site, blog, or other way and mentions product ABC in the derived content. The “mention” is a matching technique implemented here to detect the correlation of comment with its parent content. However, the decision of a parent-child correlation can also be made by using many other existing technologies such as, but not limited to, text matching, fuzzy matching, pattern recognition, voice/speech processing and recognition, content understanding, context awareness, data/text/object mining, etc., or combinations thereof.

User A specifies a content such as ABC in the current example, and applies the Tool for Product Registration 210 to. The Tool for Product Registration 210 will establish a pointer in system 100, which points to the content that the User A is working on, for example, content 250, and other necessary information regarding the content specified, for example, content ABC. Tool for Product Registration 210 may also replicate a copy of the content in system 100, so other users can search for both the specified object and the content easily within system 100.

Implementation can be done easily with virtually unlimited flexibility by a skilled developer, such variety of implementation plainly within the scope of the innovation. A specified object, such as ABC in the example, is referred to as the Product Object in content 250. Since ABC may not be the actual name of the product to be promoted, the actual product name is referred to herein as the Product. The user specifies the Product Object, which, in this example, is content ABC, and Product, and any other information asked by the Tool for Product Registration 210 in order to register the Product to be promoted. The requested information can be different from implementation to implementation. A skilled developer can make each implementation different on a case by case basis, such variety of implementation being within the scope of the innovation. For example, product ABC could be an “LED Light Bulb,” while the actual Product to be promoted is a “GE® LED.” On the other hand, the Product Object and Product could be the same in the sense of wording, such as the product ABC can be a “GE® LED”, and the corresponding Product can also be a “GE® LED” as well. After the Product is registered successfully, the content carries promotions and is available to provide for a user's benefit.

Now, assume another user, User B, observes content 250, and wants, himself, to comment on content 250. User B can use any tool to create his comment. However, if User B uses Tool for Comments 220 to make the comment or any other tools that have integrated with functions of the Tool for Comments 220, User B's comment can also become a promotion carrier and then can earn a benefit without going through the registration process that user A went through. Such a benefit can be a financial benefit such as a commission, money-back, points, etc., activity or activities to participate, and etc. A skilled developer can handle the implementation differently, such by way of a variety of implementation techniques, which shall be within the scope of the innovation. Should commission benefits be implemented, as in the current example, since User B's comment is based on User A's, User B's commission benefit may be reduced so as to provide a portion to User A, depending upon the commission policies implemented. When User B comments on User A's content, any content in User B's comment that correlate with USER A's content or with the Product Object in User A's content, such as a comment on product ABC, will be automatically and seamlessly registered as User B's Product Object, with the condition that it is a “child” Product Object as it relates to User A's content. Again, such a correlation can be made by using many existing technologies, such as for example, but not of limitation, text matching, fuzzy matching, pattern recognition, voice/speech processing and recognition, content understanding, context awareness, data/text/object mining, etc., or combinations thereof. For example, in the current example, a simple technique of text-matching may be used, and User B may say something in the comment like “Yes, I agree that product ABC works for me too.”

The system allows a user to work on any content, whether or not the content is authored or obtained by the users. For example, but not of limitation, the system provides for the case where a user can go to another user's content, and register a Product Object that the content's original author had not registered. For example, User B can register XYZ even though the content is originated by User A. User B can also register ABC with a different product from what User A registered. A skilled developer can implement different policies for whether the case where a product registration is allowed without consideration of authoring rights or with duplication or multiple products, etc., such a variety of implementation shall be within the scope of the innovation. Further, a skilled developer can implement different policies for earning benefits, calculating the financial benefits, and the way that a registration should work, such a variety of implementation shall be within the scope of the innovation.

Finally, assume there is a user, User C, who finds (or obtains) content and likes what it communicates very much. User C desires to order product ABC and/or product XYZ, and can order them from the content without going to any other online store. To do this, User C uses the Tool for Commerce 230. Tool for Commerce 230 provides User C with necessary information for purchasing product(s), such as, but not limited to, product information, possible vendors, pricing information, and all other information that a user requires in order to make decision as to where to order, and complete a transaction. Of course, system 100 will keep all accountability information required for the commerce transaction, so tracking and all activities such as commission calculation can be recorded for the product promoters, in this case, User A. If User C ordered product ABC and product XYZ, or ordered from User B's comments, then both User A and User B will benefit from the transaction. Again, any incentive action or event or other activities can be implemented or not implemented from implementation to implementation.

Tracking relationships among various instances of content is very important since it can be used to establish the basis for whatever activities such as the calculation of sales commissions. The process disclosed herein includes obtaining the chain hanger of an instance of content from which an activity such as commission is originated, tracking parent-child relationships among chained content, establishing activity such as sales commissions based upon the parent-child content relationships, and tracking the activity such as sales commissions so established.

As may be appreciated, User C may like to provide his own comments as well following his purchase of the Product in order to be involved in the activity chain such as earning the commission. Since User C is part of the marketing and sale chain, this is allowed and provided for. User C can provide his comment to User A's content or provide his comment to User B's comment.

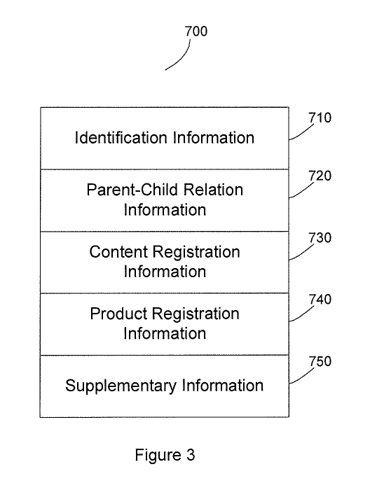

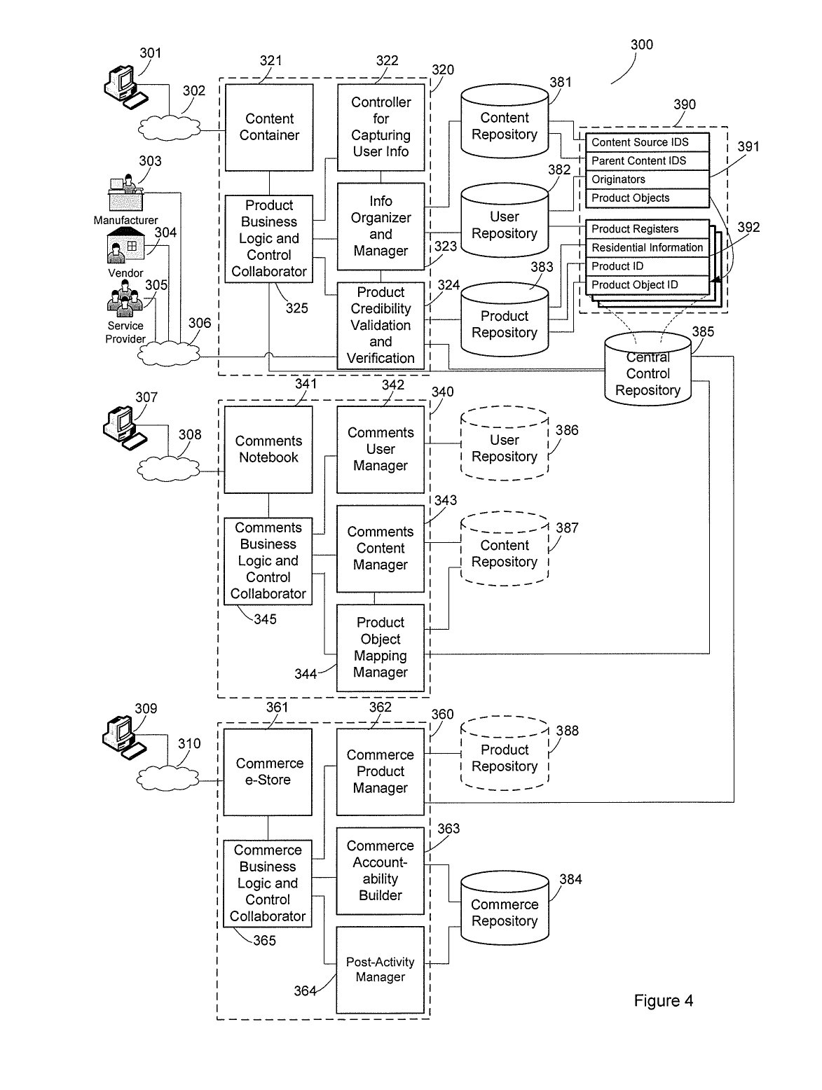

Referring now to FIG. 3, a structure of a chain hanger is shown. As will be explained further, a chain hanger is an information holder, which saves and organizes information related to and/or the pointers to content registration, product registration, association of content and product, parent-child relationship, and other data and information necessary for each specific implementation. Chain hanger structure 700 is categorized into portions such as, by way of example and not of limitation, Identification Information 710, which identifies content, object, user, product, and other data and information; Parent-Child Relationship Information 720, which specifies relationships among parent content and child content; Content Registration Information 730, which specifies registration information for content; Product Registration Information 740, which specifies registration information regarding products; and Supplementary Information 750, which specifies associations among content, objects, users, and products, as well as many other information necessary as a specific implementation may require. The afore-mentioned information can either be the pointers to actual information of any specific information or the actual information. A skilled developer can make each implementation of the chain hanger differently, on a case by case basis, with different structure and information, such variety of implementation being within the scope of the innovation. A method to implement a specific chain hanger is illustrated in FIG. 4 as 390.

Referring now to FIG. 4, a system 300 is shown to provide functions and tools to enable marketing and commerce in accordance herewith. It consists of Tool for Product Registration 320, Tool for Comments 340, Tool for Commerce 360, Content Repository 381, User Repository 382, Product Repository 383, Commerce Repository 384, and Central Control Repository 385.

As shown in FIG. 4, a dash-lined User Repository 386 is the same as User Repository 382; dash-lined Content Repository 387 is the same as Content Repository 381; dash-lined Product Repository 388 is the same as Product Repository 383. Reference to one shall be implied as reference to the other, without departure from the meaning provided.

As shown, the list implemented within Central Control Repository 385 is defined for purposes of this disclosure as Chain Hanger 390. Chain Hanger 390 consists of a List of Content Properties 391 and a Set of Product Objects 392. The Set of Product Objects 392 consists of as many Product Objects as the content contains. A Chain Hanger organizes Product Objects with content and associates or connects content, Product, content authors, and product registers together. The content heritage tree can be determined through the use of Chain Hangers. As a result thereof, activities or events, such as sales commissions can be performed, tracked or calculated from layer to layer.

A skilled developer may implement a Chain Hanger differently, such a variety of implementation shall be within the scope of the innovation.

Still referring to FIG. 4, Content Repository 381 contains all content indexed at least by Content ID. User Repository 382 contains all information about users including, but not limited to, User ID, and all other information. Product Repository 383 contains all information about Products including, but not limited to, information about the Product Object, information about the Product, information about the location of the Product Object in content, etc.

Commerce Repository 384 contains all information used for commerce purposes such as vendors who carry a product, pricing, as well as transaction accountability, etc. Central Control Repository 385 contains all the policies, algorithms, Reaction Chains, etc. that control the operation of the system 300. All repositories can be implemented by using any database technology, file repository technology, document management technology, cloud technology, large data technology, or any other available technology, and can be implemented jointly or separately.

Connectivity 302, 308, and 310 connects user client devices, which may include, but are not limited to, computers, mobile devices, wireless devices, etc. or foreign servers 301, 307, and 309 to system 300. Connectivity 306 connects systems of product manufacturers 303, product vendors 304, and product service providers 305 to system 300. All connectivities are realized through available connections such as, but not limited to, internet, intranet, wireless, or any other means.

The functions of Tool for Product Registration 320 will now be described. Content Container 321 provides a necessary tool to a client's device that frames the content specified by a user. Framing can be implemented by many existing technologies such as Uniform Resource Link (URL), Uniform Resource Identifiers (URI), or coping content into a template structure implemented by Document Object Model (DOM), Cascading Style Sheets (CSS), or other technologies. Content Container 321 facilitates specifying (usually by highlighting, marking, or other ways) an area (or called object) and specifies location of the object in the content as a Product Object.

To specify an object in content can be implemented by highlighting, marking, or other ways including but not limited to automated context and text analysis or extraction, or object extraction algorithms or methodologies or systems, or database system, or expert systems, feature extraction. The information about the Product Object can be so captured that the Product Object can be recovered next time when the content is displayed again. The information along with content specific information that assists in the recovering of content-Product-Object play back is called Residential Information. Content Container 321 is the component that associates or hooks-up user content within system 300. Although it may not necessary, the implementation of system 300 currently has Content Container 321 replicate user content and send same to system 300 to store in Content Repository 381 for the convenience of future use.

Content Container 321 sends information about the content to Product Business Logic and Control Collaborator 325, and in turn Control Collaborator 325 sends the information to Info Organizer and Manager 323 to check whether or not the content is previously registered content. If the content is already registered, information will be send back through an opposite path to client device in order to recover all already registered Product Objects in the content. Otherwise, a user may have the chance to register the content with content information along with user's information.

A user can modify the registration of an existing Product Object or register a new one. When a user specifies a new Product Object, the Content Container 321 will gather value information about that Product Object, such as characters, wording statement, image, picture, and other content object or partial of a content object, Residential Information about the Product Object, content source information such as web site link address, etc., along with a replicated copy of the content, and sends that information to Control Collaborator 325. Control Collaborator 325 will in turn operate Info Organizer and Manager 323 to organize the formation and save them into User Repository 382 and Content Repository 381 under the control of Controller for Capturing User Info 322, so user information, content information, and product objects information can each be indexed, related, and corresponded, and be easily found and searched for in future.

Content Container 321 will then work with the user to gather product information such as product name, manufacturer, specification, model, stories, vendors, service providers, etc. The information collected will be send back to Control Collaborator 325, in turn Control Collaborator 325 will operate Info Organizer and Manager 323 to organize some of the information, and operate Product Credibility Validation and Verification 324 to work with manufacturers, vendors, and services providers to validate their existence, addresses, credibility, warranties, return policies, pricing, etc. After everything is validated and verified satisfactorily, the Product will be registered in system 300. All information about the Product will be recorded in Product Repository 383. A Chain Hanger 390 will be created and recorded in Central Control Repository 385.

As described hereinabove, a Chain Hanger 390 consists of two parts: the first part being a List of Content Properties 391, and the second part being a Set of Product Objects 392.

The List of Content Properties 391 consists of: Content Source IDS, which itself consists of two basic pointers, one of which points to the content source (replicated copy) in Content Repository 381, and another of which points to the source content in foreign system; Parent Content IDS, which points to such content that the current content refers to or is derived from; Originators, which specify who are the authors of current content; and Product Objects, which points to its Set of Product Objects.

The Set of Product Objects 392 consists of as many Product Objects as the content contains. Each Product Object contains the following properties: Product Registers, which specify all the registrants who have registered the Product; Residential Information, which contains information for recovering the specified Product Object in the content; Product ID, which points to product information; and Product Object ID, which identifies the Product Object.

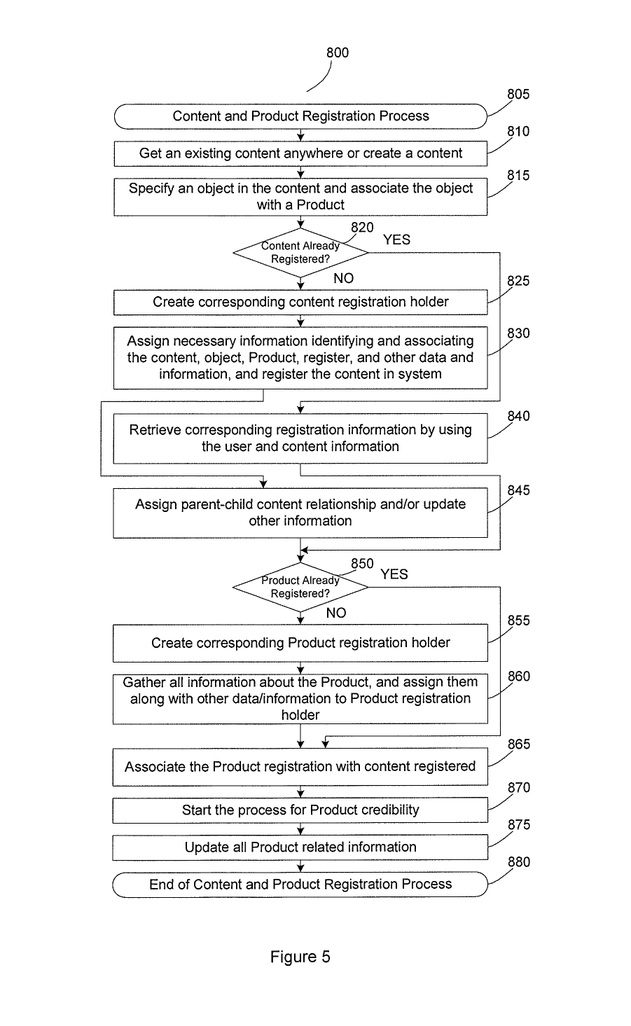

Referring now to FIG. 5, one form of a process of content and product registration 800 will be described. In step 810, a user obtains a piece of content from a source anywhere or by creating it with any software or hardware tool available. In step 815, the user specifies, with any available tools, any portion of the content as an object. In step 820, a check is performed to determine whether or not the content has already registered in the system. If the content has not already been registered in the system, the process proceeds to step 825, otherwise, it proceeds to step 840.

In step 825, a holder is created for saving and organizing registration information associated with the content. Such a holder can be implemented in the form of a database, memories, any kind of storage, disk space, files, and those that can hold structured and unstructured information and relationships that are recoverable with programs running on them. In step 830, the necessary information is assigned for identifying and associating the content, object, product, register, and other data and information into the holder, and register the content in system. Next, the process proceeds to step 845.

In step 840, if the content has already been registered, all registration information is retrieved by using information, such as user and content information. Next, the process proceeds to step 850.

In step 845, if the content was not registered before, then specify whether or not the content is related, referred to, or in other words derived from other content, especially if the content was just created by the user. Parent-child content relationship is recorded in this step along with other possible data and information that may be relevant to a specific implementation of the process. Next, the process proceeds to step 850.

In step 850, check whether or not the product specified by the user to be associated with the object is registered. If it has been registered, then associate the product with the content just registered. Otherwise, go to step 855 to create a holder for the product registration. Again, the holder has characteristics similar to those described above. In step 860, gather all information about the product, for example product manufacturer, product specification, and any other, as may be specified from one specific implementation to another. Assign that information along with other data and information into the product registration holder.

In step 865, the Product registration is associated with the content. It may be observed that an object appearing in content may have many different Products associated therewith. Certainly, a Product may also be associated with many different objects in one content or in different content.

In step 870, the process of validating and verifying Product credibility is initiated. It is noted that if a Product has already registered successfully with Product credibility validated and verified, step 870 will check whether or not there is any update available to avoid process redundancy, and set up corresponding information accordingly. In step 875, after the process of validating and verifying Product credibility is completed, the Product related information is updated in the system. In step 880, the Content and Product registration process is completed

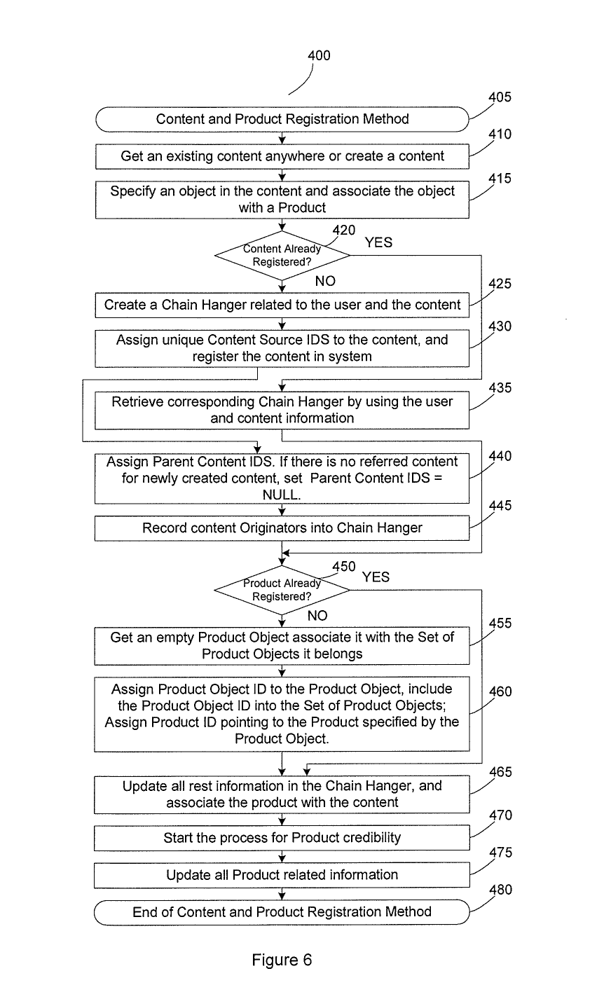

Referring now to FIG. 6, another form of a method of content and product registration 400 will now be described the method using a chain hanger to implement the process of content and product registration. In step 410, a user obtains content from a source therefore, such as a web site, a web log, XML, HTML, any electronic document, etc., or simply creates new content with or without referring to other content. In step 415, the user specifies an object in the content, which could be character(s), statement(s), a paragraph, a picture, an image, or a portion of a picture or image, or any combination of those, by highlighting the object, marking the object, or some other meanings of “specifying”.

In step 420, a check is performed to ascertain whether or not the content is already registered in the system. If the content has not already been registered in the system, the process proceeds to step 425, otherwise, it proceeds to step 435.

In step 425, a new Chain Hanger is created that is related to the user and the content. In step 430, a unique Content Source IDS is generated that points to the original content, at its original location, and the replicated copy of the content. The process then proceeds to step 440.

In step 435, using user information and content information, existing and corresponding Chain Hangers are retrieved. The process then proceeds to step 450.

In step 440, for newly created content, if there is parent content, then all of the Content Source IDS of the parent content is assigned to the Parent Content IDS of the Chain Hanger, otherwise NULL is assigned to the Parent Content IDS of the Chain Hanger. In step 445, the authors of the content are recorded into the Originators of the Chain Hanger. The Originators may be the user, or whomever the user represents, or a number of users.

In step 450, a determination is made as to whether or not the Product Object specified by the user has already registered. If it has not been registered (it is a new Product Object specified by the user in the content), then the process then proceeds to step 455, otherwise the process then proceeds to step 465.

In step 455, an empty Product Object list is obtained from the Set of Product Objects of the Chain Hanger. In step 460, a unique Product Object ID is assigned and the new Product Object ID is included in the Product Objects of the List of Content Properties of the Chain Hanger. A unique Product ID is assigned that points to the Product specified by the user. In step 465, all other information is assigned or updated in the Chain Hanger, if necessary.

In step 470, the process of validating and verifying Product credibility is initiated. In step 475, after the process of validating and verifying Product credibility is completed, the Product related information is updated in the system. In step 480, the product registration process is completed.

Referring again to FIG. 4, the functions of the Tool for Comments 340 will be described. The Comments Notebook 341 provides a tool that is needed to enable a user to provide comments on a particular content. Although a user can provide his or her comments using many existing tools, those tools do not provide interaction between comments and the system 300 unless an integration step is performed. The Comment Notebook 341 can be implemented with any technology that allows integration with system 300.

Through Comments Business Logic and Control Collaborator 345, the Comments User Manager 342 ensures that comments from Comments Notebook 341 are appropriately registered and indexed with corresponding users. The Comments Content Manager 343 ensures that the comments are saved in Content Repository 381, with the appropriate relationship to the user established. As may be appreciated, the comments also become content in the system. The Product Object Mapping Manager 344 works with Comments Content Manager 343 and Comments Business Logic and Control Collaborator 345, to perform correlation detection between comment content and the content of its parent content or Product Object of its parent content and automatically map Product Objects of the content into comments, create a new Chain Reaction for the comments, and save the Chain Reaction in the Central Control Repository 385. In view thereof, the Product Object Mapping Manager 344 and the Chain Reaction make up key elements of the system disclosed herein. The mapping happens per a correlation of comment content with content of its parent content or with Product Object of its parent content.

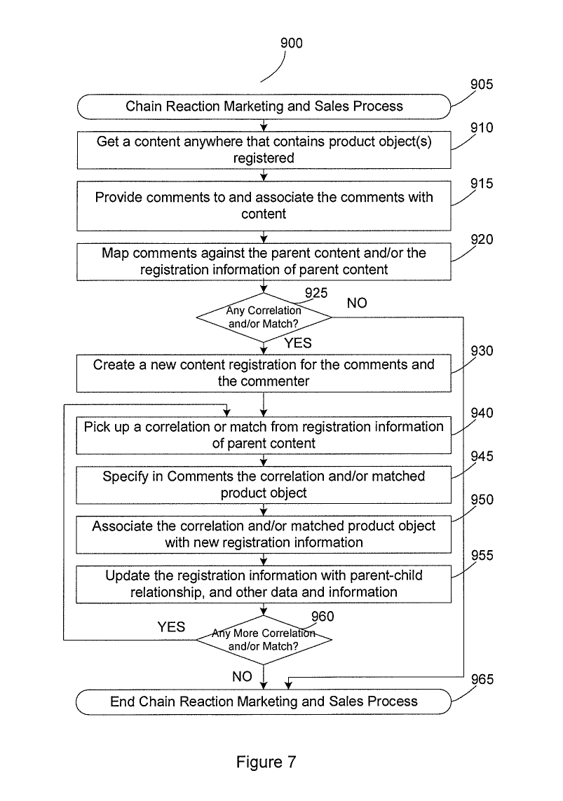

Referring now to FIG. 7, one form of a process for chain reaction marketing and sales 900 is presented. In step 910, a user obtains content from a source anywhere, which is called parent content and contains registered Product Object(s). In step 915, the user generates comments relating to the content, and the comments are associated with the parent content. In step 920, the content of the comments, which is called child content, will be mapped against the parent content or registration information of the parent content to seek out correlations and/or matches of objects in the contents in step 925. If there is no correlation and/or match, the comment does not initiate a chain reaction for product marketing and sales, and the process ends without further action. If there is a match, in step 930, a new content registration is created for the comments and the commenter who is the user. In step 940, a correlated or matched Product Object is selected from the parent content registration information and, in step 945, the object in the child content is specified, i.e. the comments with the Product in the Product Object from the parent content registration information. In step 950, the object and Product is associated with the new registration information of the child content along with other data and information that may be necessary for a specific implementation. In step 955, registration information of the child content is updated using the parent-child content relationship along with other data and information that may be necessary for a specific implementation. Step 960 determines whether all correlations and/or matches of Product Objects are dealt with using the steps described above until the process completes. The decision of whether or not such a correlation and/or match exists can be made by using many existing technologies such as, but not limited to, text matching, fuzzy matching, pattern recognition, voice/speech processing and recognition, content understanding, context awareness, data/text/object mining, etc.

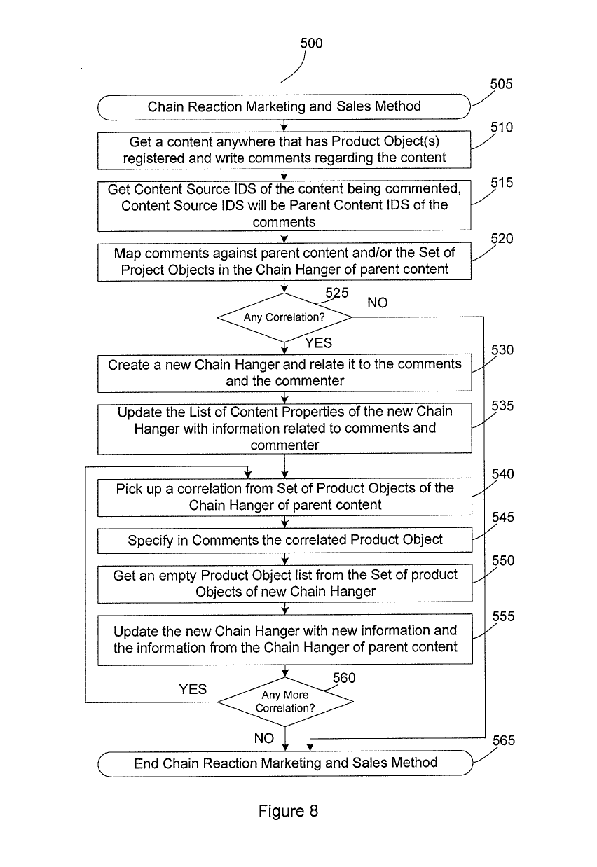

Referring now to FIG. 8, another form of a method for chain reaction marketing and sales is presented, which uses a chain hanger to implement the process of chain reaction marketing and sales. In step 510, a user obtains content from anywhere, such as a web site, a web log, XML, HTML, any electronic document, etc., which contain registered Product Objects.

In step 515, the Content Source IDS is retrieved from the Chain Hanger of the content. The Content Source IDS serves as Parent Content IDS of the new Chain Hanger of the comments to be moved to the content.

In step 520, after the comments are completed or during the course of commenting, a check is performed to verify whether or not there is a correlation between comments and parent content or a Product Object in the parent content's Chain Hanger. In step 525, if there is any match, then go to step 530, otherwise proceed to step 565.

In step 530, a new Chain Hanger is created and related to the commenter and the comments. In step 535, the List of Content Properties of the new Chain Hanger is updated with proper information, as described hereinabove.

In step 540, a match from the Set of Product Objects of the parent Chain Hanger is selected. In step 545, the matched Product Object is specified in comments. The “correlate” or “match” is specified is a generic term. The decision of whether or not such a correlation or match exists can be made by using many technologies, including, but not limited to, text matching, fuzzy matching, pattern recognition, voice/speech processing and recognition, content understanding, context awareness, data/text/object mining, etc., or combinations thereof. A skilled developer can implement different algorithms for the correlation and matching, such a variety of implementation shall be within the scope of the innovation.

In step 550, an empty Product Object list from the Set of Product Objects of the new Chain Hanger is obtained. In step 555, all elements in the Product Object list and the rest of the new Chain Hanger are updated.

In step 560, if there are any more matches, then proceed to step 540, otherwise go to step 565. In step 565, the Chain Reaction Marketing and Sales Process is completed.

Referring again to FIG. 4, the functions of the Tool for Commerce 360 will now be described. The Commerce e-Store 361 provides a tool for a user to purchase Products from within content. When the tool is applied to a Product Object within content, the Commerce e-Store 361 will deliver the information about the Product Object, the content, and user information to Commerce Business Logic and Control Collaborator 365. The Commerce Business Logic and Control Collaborator 365 will operate Commerce Product Manager 362 to fetch all information required by a user in order to decide what and where to order. The Product information will be delivered to a user via the Commerce e-store 361. According to this information, a user will purchase the Product.

After a transaction is completed, Commerce Business Logic and Control Collaborator 365 operates Commerce Accountability Builder 363 to record the transaction accountability, and will also operate Post-Activity Manager 364 to perform post activities such as commission calculations, coupon distributions, money-back calculations, and other activities that a specific implementation may interested in. Both Commerce Accountability Builder 363 and Post-Activity Manager 364 work with Commerce Repository 384.

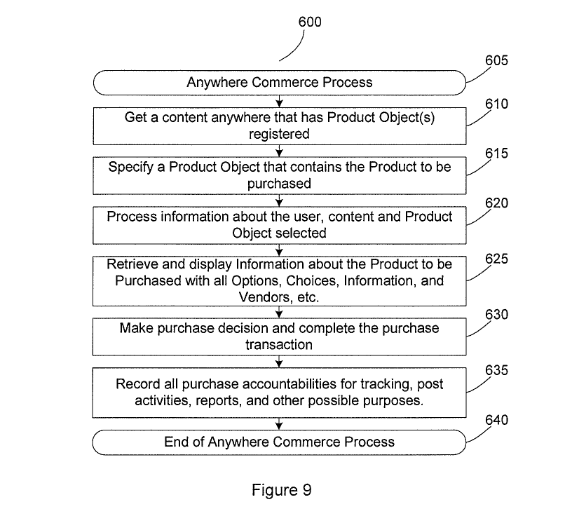

Referring now to FIG. 9 a process for conducting commerce anywhere will be described. In step 610, a user obtains content from anywhere, such as, not limited to, a web site, a web log, XML, HTML, any electronic document, etc., which contains registered Product Objects. In step 615, the user specifies a Product Object from content, which contains the Product that the user wants to purchase. In step 620, information is processed about the user, the content, and the Product Object. In step 625, all information regarding the purchase of the Product is retrieved.

In step 630, the user makes a purchase decision, and completes the purchase transaction. In step 635, all accountability information for tracking, post activities, reports, and other possible purposes is recorded. In step 640, the Commerce Process is completed.

In summary, there is a Content, cᵢ, from Content set C, i.e. cᵢεC, where C={c₁, c₂, . . . , cᵢ, . . . }. cᵢ→cid•→Original Content of cᵢ; cᵢ→CIDS^{p}•→None or one or many parent Content, where CIDS^{p}={cid₁, cid₂, cidᵢ . . . }; cᵢ→OIDS•→At least one authors, where OIDS={oid₁, oid₂, oidᵢ . . . }; cᵢ→POS, There are as many Product Objects as registered, where POS={po₁, po₂, poᵢ . . . };

For each and every poⱼ, cᵢ→POS•poⱼ→poid•→Product Object uniquely; cᵢ→POS•poⱼ→rinfo•→Residential Information uniquely locating Product Object poⱼ in cᵢ; cᵢ→POS•poⱼ→pid•→Product associated with poⱼ; cᵢ→POS•poⱼ→*RIDS•→At least one Product Register, where RIDS={rid₁, rid₂, ridᵢ . . . }.

### Process and Algorithm:

```
    STEP 1: Search for a c in C, where C = {c₁, c₂, ..., cᵢ, ...};
    STEP 2: If there exists a cᵢ in C that c = cᵢ, then go to STEP 4,
otherwise go to STEP 3;
    STEP 3: Create c and assign the following properties to the c:
        Assign c→cid = a unique cid so that c→cid ·→|c|;
        Assign c→CIDS^{p} = EMPTY if there is no referred cᵢ;
        Assign c→CIDS^{p} = all those cid's which point to all referred
    cᵢ ε C;
        Assign c→OIDS = all oid's that point to at least one author
    who created the c (there is at least one oid);
    STEP 4: To establish a Product Object in the c, go to STEP 7,
otherwise go to STEP 5;
    STEP 5: To make a comments on c, go to STEP 12, otherwise go
to STEP 6:
    STEP 6: To purchase a Product on c, go to STEP 15, otherwise go
to STEP END;
    STEP 7: Specify a Product Object, po, where po ∃ [symbol]   POS (po is not
in set POS);
        Assign c→POS·po→poid = unique Product Object ID;
        Assign c→POS·po→rinfo = Residential Information uniquely
    locating Product Object po in c;
        Assign c→POS·po→RIDS = at least one Product Registers,
    where RIDS = {rid₁, rid₂, ridᵢ ...};
    STEP 8: If the Product is already in system, then
        Assign c→POS·po→pid = Product ID, go to STEP END;
        ELSE go to STEP 9;
    STEP 9: Give information about the Product, initiate Product
Credibility Process;
    STEP 10: After the Product Credibility Process completes, if it
returns with success, THEN
        Assign c→POS·po→pid = Product ID newly created, go to
    STEP END;
        ELSE go to STEP 11
    STEP 11: Notify the failure to Product Object register, and
        Assign c→POS·po→pid = NULL, go to STEP END;
    STEP 12: Create cⱼ and assign the following properties to the cⱼ:
        Assign cⱼ→cid = a unique cid so that cⱼ→cid ·→ |cⱼ|;
        Assign cⱼ→CIDS^{p} = c→cid ∪ CIDS^{p};
        Assign cⱼ→OIDS = at least one oid's which point to at least
    one authors who created the cⱼ;
    STEP 13: Assign i = 0
        FOR k = 1 TO ||c→POS||
        For each match in cⱼ to a Product Object in c→POS·poₖ
            i = i + 1
            Assign cⱼ→POS·poᵢ→poid = c→POS·poₖ→poid;
            Assign cⱼ→POS·poᵢ→rinfo = Residential Information
        uniquely locating poᵢ in cⱼ;
            Assign cⱼ→POS·poᵢ→RIDS = at least one Product
        Registers;
            Assign cⱼ→POS·poᵢ→pid = c→POS·poₖ→pid;
    STEP 14: Go to END;
    STEP 15: Select a poᵢ from c→POS
    STEP 16: Process and display all information regarding the
Product;
    STEP 17: Make purchase decision, and complete transaction;
    STEP 18: Record all accountability for future tracking, post
activities, report, and other possible purposes.
    END.
```

As may be appreciated, the present invention may be embodied as a system, method, or computer program product. The present invention may take the form of a hardware embodiment, a software embodiment or a combination of software and hardware. Furthermore, the present invention may take the form of a computer program product embodied in any tangible storage of expression having computer-usable program code embodied in the medium. The computer-usable or computer-readable medium may be any medium that can contain, store, or communicate, for use by or in connection with the instruction execution system, apparatus, or device. The computer-usable or computer-readable medium may be, for example, an electronic, magnetic, optical, electromagnetic, infrared, or semiconductor system, apparatus, or device.

An exemplary environment for implementing various aspects of system and method disclosed herein includes a computer. The computer includes a processing unit (CPU), system memory, and a system bus. The system bus couples system components including, but not limited to, the system memory to the processing unit. The processing unit can be any of various available processors. Dual microprocessors and other multiprocessor architectures also can be employed as the processing unit. Multiple computers can of course be utilized in the system and method disclosed herein.

The system bus can be any of several types of bus structure(s) including the memory bus or memory controller, a peripheral bus or external bus, and/or a local bus using any variety of available bus architectures including, but not limited to, 15-bit bus, Industrial Standard Architecture (USA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory includes volatile memory and nonvolatile memory. The basic input/output system (BIOS), containing the basic routines to transfer information between elements within the computer, such as during start-up, is stored in nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computers useful in the practice of the methods and systems disclosed herein also include removable/nonremovable, volatile/nonvolatile computer readable storage media, for example, disk storage. Disk storage includes, but is not limited to, devices like a magnetic disk drive, floppy disk drive, tape drive, Jaz drive, Zip drive, LS-100 drive, flash memory card, or memory stick. In addition, disk storage can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices to the system bus, a removable or non-removable interface is typically used such as interface.

It is to be appreciated that software is contemplated to act as an intermediary between users and the basic computer resources described herein. Such software includes an operating system. Such an operating system can be stored on disk storage and acts to control and allocate resources of the computer system. System applications take advantage of the management of resources by operating system through program modules and program data stored either in system memory or on disk storage. It is to be appreciated that the present invention can be implemented with various operating systems or combinations of operating systems.

A user enters commands or information into the computer through input device(s). Input devices include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit through the system bus via interface port(s). Interface port(s) include, for example, a serial port, a parallel port, a game port, and a universal serial bus (USB). Output device(s) use some of the same type of ports as input device(s). Thus, for example, a USB port may be used to provide input to the computer and to output information from the computer to an output device. An output adapter may be provided output devices like monitors, speakers, and printers among other output devices that require special adapters. The output adapters include, by way of illustration and not limitation, video and sound cards that provide a means of connection between the output device and the system bus. It should be noted that other devices and/or systems of devices provide both input and output capabilities such as remote computer(s).

The system computer(s) can operate in a networked environment using logical connections to one or more remote computers, such as remote computer(s). The remote computer(s) can be a personal computer, a server, a router, a network PC, a workstation, a microprocessor based appliance, a peer device or other common network node and the like, and typically includes many or all of the elements described relative to the computer(s). Remote computer(s) may be logically connected to the system computer(s) through a network interface and then physically connected via communication connection. The network interface encompasses communication networks such as local-area networks (LAN) and wide-area networks (WAN). LAN technologies include Fiber Distributed Data Interface (FDDI), Copper Distributed Data Interface (CDDI), Ethernet/IEEE, Token Ring/IEEE and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) include the hardware/software employed to connect the network interface to the bus. The hardware/software necessary for connection to the network interface includes, for exemplary purposes only, internal and external technologies such as, modems including regular telephone grade modems, cable modems and DSL modems, ISDN adapters, and Ethernet cards.

It is to be appreciated that the functionality of the present invention can be implemented using JAVA, XML or any other suitable programming language. The present invention can be implemented using any similar suitable language that may evolve from or be modeled on currently existing programming languages. Furthermore, the system and method disclosed herein can be implemented as a stand-alone application, as web page-embedded applet, or by any other suitable means.

Additionally, one skilled in the art will appreciate that this invention may be practiced on computer networks alone or in conjunction with other means for submitting information for customization of lyrics including but not limited to kiosks, facsimile or mail submissions and voice telephone networks. Furthermore, the invention may be practiced by providing all of the above-described functionality on a single stand-alone computer, rather than as part of a computer network.

The system disclosed herein may include one or more client(s). The client(s) can be hardware and/or software (e.g., threads, processes, computing devices). The system may also include one or more server(s). The server(s) can also be hardware and/or software (e.g., threads, processes, computing devices). One possible communication between a client and a server may be in the form of a data packet adapted to be transmitted between two or more computer processes. The system may include a communication framework that can be employed to facilitate communications between the client(s) and the server(s). The client(s) may be operably connected to one or more client data store(s) that can be employed to store information local to the client(s). Similarly, the server(s) may be operably connected to one or more server data store(s) that can be employed to store information local to the servers.

In other forms, the invention provides a business method that performs the steps of the invention on a subscription, advertising, and/or fee basis. That is, a service provider could offer to perform the processes described herein, such as, for example, product registration or conducting chain reaction marketing. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties. In further embodiments, the server and the software/applications on a client may be designed and managed for free or for a fee by the beneficiary or by an independent entity.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A process of associating a product with content for use in an online system for marketing and/or commerce, comprising the steps of (a) creating content or obtaining content from a source; (b) specifying an object in the content; and (c) specifying a product and associating the product with the object to form a product object.

A2. The process of paragraph A1, further comprising the steps of: (d) establishing at least one pointer to or at least one holder containing information relating to at least one element, the at least one element selected from content, user, object, or other data and information or combinations thereof; and (e) registering the associated product.

A3. The process of paragraph A2, wherein the object is selected from one or more characters, one or more statements, one or more paragraphs, one or more pictures, one or more images, one or more voices, one or more other kind of media, or combinations or portions thereof.

A4. The process of paragraph A2, further comprising the step of: (f) determining if the product object specified was previously registered and if not, creating a new product registration holder, assigning all information gathered for the product along with other data and information to the new product registration holder, and associating the new product registration with the content.

A5. The process of paragraph A2, further comprising the step of: (f) determining if the product object specified was previously registered and if so, associating the product to the object by assigning information or updating the registration holder.

A6. The process of paragraph A5, further comprising the steps of: (g) validating and verifying product credibility; and (h) updating product related information in the system.

A7. The process of paragraph A1, wherein in step (a), the content is obtained from a web site, web content, a web log/forum, XML content, HTML content, an electronic document, or an electronic content.

B1. A process of registering content with one or more products in an online system for marketing and/or commerce, comprising the steps of: (a) creating content or obtaining content from a source; (b) specifying an object in the content; and (c) specifying a product and associating the product with the object.

B2. The process of paragraph B1, further comprising the steps of: (d) establishing at least one pointer to or at least one holder containing information relating to at least one element, the at least one element selected from content, user, object, or other data and information or combinations thereof; and (e) registering the content with the associated product.

B3. The process of paragraph B2, wherein the object is selected from one or more characters, one or more statements, one or more paragraphs, one or more pictures, one or more images, one or more voices, one or more other kind of media, or combinations or portions thereof.

B4. The process of paragraph B3, further comprising the step of: (f) determining whether the content was previously registered in the system, the determining comprising: (i) if the content was not previously registered, creating a new content registration holder that is associated with the user and the content and generating information necessary to identify and associate the content, object, product, register, and other data and information; (ii) if the content was previously registered, retrieving existing and corresponding registration information using user information and content information; and (iii) for newly created content having parent content, recording parent-child content relationship.

B5. The process of paragraph B1, wherein the step of specifying an object in the content comprises highlighting the object or marking the object.

B6. The process of paragraph B2, wherein the unique content source pointers or holders are generated so as to point to or hold information of the original content at an original location of the original content, and create a replicated copy of the content.

C1. A process for integrating parent content and child content, comprising the steps of: obtaining or creating new content (child content) having at least one object therein; verifying if the at least one object in the child content correlates with at least one object in other content (parent content); and if there is a correlation, then associating a product object specified with parent content with the child content.

C2. The process of paragraph C1, further comprising the steps of: registering the child content with product information from the corresponding product object associated with the parent content; and recording a parent-child content relationship.

D1. A process for tracking activities based on content registration, comprising the steps of: obtaining content; establishing a parent-child content relationship from information associated with the content; tracking parent-child content relationships; and establishing an activity schedule based upon a parent-child content relationship.

D2. The process of paragraph D1, further comprising the step of tracking the established activities.

E1. A process for chain reaction marketing and sales, the process comprising the steps of: (a) obtaining content (parent content) with product(s) or product object(s) associated therewith; (b) obtaining or creating additional content (child content); and (c) verifying if an object in the child content correlates with an object in the parent content or a product object specified in the parent content and if there is a correlation, then associating the product(s) or product object(s) associated with the parent content with the child content, and registering the comments as child content of the parent content with an associated commenter.

E2. The process of paragraph E1, further comprising the step of associating the child content with the parent content.

F1. A chain hanger structure for use in a computer-based online system for conducting marketing and commerce, comprising: an Identification Information Holder or Pointer; a Parent-Child Relation Information Holder or Pointer; a Content Registration Information Holder or Pointer; a Product Registration Information Holder or Pointer; and a Supplementary Information Holder or Pointer.

F2. A method of implementing the chain hanger structure of paragraph F1, comprising the steps of: providing a list of content properties; and providing a set of product objects, wherein the chain hanger structure is configured to organize product objects with content and associate content, products, content authors, content and product registers, content registration, and product registration with one another, and track content parent-child relationships.

F3. The method of paragraph F2, wherein the list of content properties includes: a set of Content Source IDS, which holds information related to or provides at least one pointer pointing to at least one source content; a set of Parent Content IDS, which holds information related to or provides at least one pointer pointing to at least one parent content; a set of Originators, which holds information related to or provides at least one pointer pointing to at least one originator of the content; and a set of Product Objects, which holds information related to or provides at least one pointer pointing to at least one identification of Product Object.

F4. The method of paragraph F2, wherein the set of product objects includes: a set of Product Registers, which holds information related to or provides at least one pointer pointing to at least one product register; a Residential Information, which holds information related to or provides a pointer pointing to information that recovers indication of product objects in a content when the content is displayed again; a Product ID, which holds information related to or provides a pointer pointing to a product registration information; and a Product Object ID, which holds information related to or provides pointer pointing to its identification of the product object, wherein the Product Object ID is pointed or indexed by an element of Product Objects in a list of content properties.

G1. A method of product registration in an online system for marketing and commerce, comprising the steps of: (a) creating content or obtaining content from a source; (b) specifying an object in the content; (c) specifying a product and associating the product with the object to form a product object; (d) registering the associated product; and (e) determining if the product object specified was previously registered and if not, obtaining an empty product object from a set of product objects of a chain hanger and assigning a unique product object ID and including the product object ID in the product objects of a list of content properties of the chain hanger.

G2. The method of paragraph G1, further comprising the steps of: (f) determining if the product object specified was previously registered and if so, assigning information or updating the chain hanger; (g) validating and verifying product credibility; and (h) updating product related information in the system.

G3. The method of paragraph G2, wherein in step (a), the content is obtained from a web site, a web content, a web log, XML content, HTML content, an electronic document, or an electronic content.

G4. The method of paragraph G1, further comprising the step of establishing at least one pointer to or at least one holder containing information relating to at least one element, the at least one element selected from content, user, object, or other data and information or combinations thereof, the step of establishing at least one pointer or at least one holder conducted prior to the step of registering the associated product.

G5. The method of paragraph G1, wherein the object is selected from one or more characters, one or more statements, one or more paragraphs, one or more pictures, one or more images, one or more voices, one or more other kind of media, or combinations or portions thereof.

H1. A method of registering content with one or more products in an online system for marketing and commerce, comprising the steps of: (a) creating content or obtaining content from a source; (b) specifying an object in the content; (c) specifying a product and associating the product with the object; (d) registering the content with the associated product; and (e) determining whether the content was previously registered in the system, the determining comprising: (i) if the content was not previously registered, creating a new chain hanger that is associated with the user and the content and generating a unique content source IDS; (ii) if the content was previously registered, retrieving existing and corresponding chain hangers using user information and content information; and (iii) for newly created content having parent content, assigning the content source IDS of the parent content to a parent content IDS of the chain hanger for newly created content having parent content, assigning a value of NULL to the parent content IDS of the chain hanger should no parent content exist; and (f) recording the authors of the content as originators of the chain hanger.

H2. The method of paragraph H1, wherein the step of specifying an object in the content comprises highlighting the object or marking the object.

H3. The method of paragraph H2, wherein the unique content source IDS is generated so as to point to the original content at an original location of the original content, and create a replicated copy of the content.

I1. A method for chain reaction marketing and sales, the method comprising the steps of: (a) obtaining content (parent content) containing registered product objects and a chain hanger; (b) retrieving a content source IDS from the chain hanger of the parent content; (c) providing and associating comments with the parent content; (d) verifying if an object in the comment correlates an object in the parent content or a product object in the parent content and if there is a correlation, then creating a new chain hanger and relating the new chain hanger to a commenter and the comments; and (e) updating a list of content properties of the new chain hanger.

I2. The process of paragraph I1, further comprising the steps of: correlating a set of product objects from the parent content and associating the correlated product objects in the comments; obtaining an empty product object list from the set of product objects of the new chain hanger; and updating elements in the product object list and the new chain hanger, wherein the content source IDS serves as a parent content IDS of the new chain hanger of the comments, wherein the content includes a web site, a web content, a web log, XML content, HTML content, an electronic document, an electronic content, or combinations or portions thereof.

J1. A process for conducting online commerce, the process comprising the steps of: (a) obtaining content having associated therewith registered product objects; (b) specifying a product object from the content that contains a product that a user wants to purchase; (c) processing information about the user, the content, the product object, and other data and information; (d) retrieving product purchasing information; and (e) completing a purchase transaction.

J2. The process of paragraph J1, further comprising the step of: (f) recording all accountability information for tracking, post activities, and reporting.

J3. The process of paragraph J1, wherein the content includes a web site, a web content, a web log, XML content, HTML content, an electronic document, an electronic content, or combinations or portions thereof.

K1. A method for conducting chain reaction marketing and commerce, the method comprising: (a) registering content; (b) registering a product; (c) conducting chain reaction marketing; and (d) conducting online commerce, wherein the step of conducting the online commerce includes: (i) obtaining content having associated therewith registered product objects; (ii) specifying a product object from the content that contains a product that a user wants to purchase; (iii) processing information about the user, the content, the product object, and other data and information; (iv) retrieving product purchasing information; and (v) completing a purchase transaction.

K2. The method of paragraph K1, wherein the step of registering the content further comprises: (i) creating the content or obtaining the content from a source; (ii) specifying an object in the content, the object selected from one or more characters, one or more statements, one or more paragraphs, one or more pictures, one or more images, one or more voices, one or more other kind of media, or combinations or portions thereof; (iii) determining whether the content was previously registered in the system; (iv) if the content was not previously registered, creating a new chain hanger that is related to the user and the content and generating a unique content source IDS; (v) if the content was previously registered, retrieving existing and corresponding chain hangers using user information and content information; (vi) for newly created content having parent content, assigning the content source IDS of the parent content to a parent content IDS of the chain hanger for newly created content having parent content, or assigning a value of NULL to the parent content IDS of the chain hanger should no parent content exist; and (vii) recording authors of the content as originators of the chain hanger.

K3. The method of paragraph K2, wherein the step of registering the product further comprises (i) determining if the product object specified was previously registered and if not, an empty product object list is obtained from a set of product objects of the chain hanger and a unique product object ID is assigned and the product object ID is included in the product objects of a list of content properties of the chain hanger.

K4. The method of paragraph K3, wherein the step of registering the product further comprises (ii) determining if the product object specified was previously registered and if so, information is assigned or updated in the chain hanger.

K 5. The method of paragraph K1, wherein the step of conducting the chain reaction marketing further comprises: (i) obtaining content having associated therewith registered product objects and a chain hanger; (ii) retrieving a content source IDS from the chain hanger of the content; (iii) providing and associating comments with the content; (iv) verifying if an object in the comment correlates an object in the parent content or a product object in the parent content's chain hanger and if there is a correlation, then a new chain hanger is created and related to a commenter and the comments; and (v) updating a list of content properties of the new chain hanger.

K6. The method of paragraph K5, wherein the step of conducting the chain reaction marketing further comprises correlating a set of product objects from the parent chain hanger and associating the matched product objects in the comments.

K7. The method of paragraph K6, wherein the step of conducting the chain reaction marketing further comprises obtaining an empty product object list from the set of product objects of the new chain hanger.

K8. The method of paragraph K7, wherein the step of conducting the chain reaction marketing further comprises updating all elements in the product object list and the new chain hanger.

L1. A computer-based online system for conducting chain reaction marketing and commerce, the system comprising: (a) a central control repository configured to manage system information, the central control repository operatively connected to a plurality of system tools, including a tool for product registration, a tool for providing comments, and a tool for conducting commerce; (b) a content repository configured to store and manage system content, the content repository operatively connected to the tool for product registration and the tool for providing comments; (c) a user repository configured to store and manage user information, the user repository operatively connected to the tool for product registration and the tool for providing comments; (d) a product repository configured to store and manage product information, the product repository operatively connected to the tool for product registration and the tool for conducting commerce; and (e) a commerce repository configured to store and manage commercial information, the commerce repository operatively connected to the tool for conducting commerce.

L2. The system of paragraph L1, wherein the central control repository implements chain hangers.

L3. The system of paragraph L2, wherein each of the chain hangers includes a list of content properties and a set of product objects.

L4. The system of paragraph L3, wherein each of the chain hangers organizes product objects with content and associates content, products, content authors, and product registers together.

L5. The system of paragraph L4, further comprising a content heritage tree configured to manage a plurality of chain hangers in a layered format, the content heritage tree configured to establish post-activities.

L6. A computer system for conducting chain reaction marketing and commerce, the system comprising: a CPU, a computer readable memory, and a computer readable storage media; first program instructions to register content; second program instructions to register a product; third program instructions to conduct chain reaction marketing; and fourth program instructions to conduct online commerce, wherein the fourth program instructions to conduct online commerce includes: (i) obtaining content having associated therewith registered product objects and a chain hanger; (ii) specifying a product object from the content that contains a product that a user wants to purchase; (iii) processing information about the user, the content, the product object, and other data and information; (iv) retrieving product purchasing information; and (v) completing a purchase transaction, wherein the first through fourth program instructions are stored on the computer readable storage media for execution by the CPU via the computer readable memory.

L7. The computer system of paragraph L6, wherein the first program instructions to register the content comprises: (i) creating the content or obtaining the content from a source of content; (ii) specifying an object in the content, the object selected from one or more characters, one or more statements, one or more paragraphs, one or more pictures, one or more images, one or more voices, one or more other kind of media, or combinations or portions thereof; (iii) determining whether the content was previously registered in the system; (iv) if the content was not previously registered, creating a new chain hanger that is related to the user and the content and generating a unique content source IDS; (v) if the content was previously registered, retrieving existing and corresponding chain hangers using user information and content information; (vi) for newly created content having parent content, assigning the content source IDS of the parent content to a parent content IDS of the chain hanger for newly created content having parent content, or assigning a value of NULL to the parent content IDS of the chain hanger should no parent content exist; and (vii) recording authors of the content as originators of the chain hanger.

L8. The computer system of paragraph L7, wherein the second program instructions to register the product comprises (i) determining if the product object specified was previously registered and if not, an empty product object list is obtained from a set of product objects of the chain hanger and a unique product object ID is assigned and the product object ID is included in the product objects of a list of content properties of the chain hanger.

L9. The computer system of paragraph L8, wherein the step of registering the product further comprises (ii) determining if the product object specified was previously registered and if so, information is assigned or updated in the chain hanger.

L10. The computer system of paragraph L1, wherein the third program instructions to conduct the chain reaction marketing comprises: (i) obtaining content having associated therewith registered product objects and a chain hanger; (ii) retrieving a content source IDS from the chain hanger of the content; (iii) providing and associating comments with the content; (iv) verifying if an object in the comment correlates an object in the parent content or a product object in the parent content's chain hanger and if there is a match, then a new chain hanger is created and related to a commenter and the comments; and (v) updating a list of content properties of the new chain hanger.

L11. The computer system of paragraph L10, wherein the third program instructions to conduct the chain reaction marketing further comprises correlating a set of product objects from the parent chain hanger and associating the matched product objects in the comments.

L12. The computer system of paragraph L11, wherein the third program instructions to conduct the chain reaction marketing further comprises obtaining an empty product object list from the set of product objects of the new chain hanger.

L13. The computer system of paragraph L12, wherein the third program instructions to conduct the chain reaction marketing further comprises updating all elements in the product object list and the new chain hanger.

M1. A computer program product comprising a computer readable storage medium having readable program code embodied in the storage medium, the computer program product includes at least one component operable to: create content or obtain content from a source; specify an object in the content; specify a product and associating the product with the object to form a product object; and register the associated product.

M2. The computer program product of paragraph M1, further comprising at least one component operable to establish at least one pointer to or at least one holder containing information relating to at least one element, the at least one element selected from content, user, object, or other data and information or combinations thereof.

M3. The computer program product of paragraph M1, wherein the object is selected from one or more characters, one or more statements, one or more paragraphs, one or more pictures, one or more images, one or more voices, one or more other kind of media, or combinations or portions thereof.

N1. A method implemented in a computer infrastructure comprising a combination of hardware and software, the method comprising: creating content or obtaining content from a source of content; specifying an object in the content; specifying a product and associating the product with the object to form a product object; and registering the associated product.

N2. The method of paragraph N1, wherein a service provider at least one of creates, maintains, deploys and supports the computer infrastructure.

N3. The method of claim N2, wherein the steps of paragraph N1 are provided by a service provider on a subscription, advertising, and/or fee basis.

N4. The method of paragraph N1, further comprising the step of establishing at least one pointer to or at least one holder containing information relating to at least one element, the at least one element selected from content, user, object, or other data and information or combinations thereof, the step of establishing at least one pointer or at least one holder conducted prior to the step of registering the associated product.

N5. The method of paragraph N4, wherein the object is selected from one or more characters, one or more statements, one or more paragraphs, one or more pictures, one or more images, one or more voices, one or more other kind of media, or combinations or portions thereof.

### INDUSTRIAL APPLICABILITY

The systems and methods disclosed herein are applicable to the online commerce industry.

All patents, test procedures, and other documents cited herein, including priority documents, are fully incorporated by reference to the extent such disclosure is not inconsistent with this disclosure and for all jurisdictions in which such incorporation is permitted.

While the illustrative embodiments disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which the disclosure pertains.

What is claimed is:

1. A process of associating a product with content for use in an online system for marketing and/or commerce, comprising the steps of:
(a) creating content or obtaining content from a source;
(b) specifying an object in the content; and
(c) specifying a product and associating the product with the object to form a product object.

2. The process of claim 1, further comprising the steps of:
(d) establishing at least one pointer to or at least one holder containing information relating to at least one element, the at least one element selected from content, user, object, or other data and information or combinations thereof; and
(e) registering the associated product.

3. The process of claim 2, further comprising the step of:
(f) determining if the product object specified was previously registered and if not, creating a new product registration holder, assigning all information gathered for the product along with other data and information to the new product registration holder, and associating the new product registration with the content.

4. The process of claim 2, further comprising the step of:
(f) determining if the product object specified was previously registered and if so, associating the product to the object by assigning information or updating the registration holder.

5. The process of claim 4, further comprising the steps of:
(g) validating and verifying product credibility; and
(h) updating product related information in the system.

6. A process of registering content with one or more products in an online system for marketing and/or commerce, comprising the steps of:
(a) creating content or obtaining content from a source;
(b) specifying an object in the content; and
(c) specifying a product and associating the product with the object.

7. The process of claim 6, further comprising the steps of:
(d) establishing at least one pointer to or at least one holder containing information relating to at least one element, the at least one element selected from content, user, object, or other data and information or combinations thereof; and
(e) registering the content with the associated product.

8. The process of claim 7, further comprising the step of:
(f) determining whether the content was previously registered in the system, the determining comprising:
(i) if the content was not previously registered, creating a new content registration holder that is associated with the user and the content and generating information necessary to identify and associate the content, object, product, register, and other data and information;
(ii) if the content was previously registered, retrieving existing and corresponding registration information using user information and content information; and
(iii) for newly created content having parent content, recording parent-child content relationship.

9. The process of claim 8, wherein the unique content source pointers or holders are generated so as to point to or hold information of the original content at an original location of the original content, and create a replicated copy of the content.

10. A process for integrating parent content and child content, comprising the steps of:
obtaining or creating content (child content) having at least one object therein;
verifying if the at least one object in the child content correlates with at least one object in other content (parent content); and
if there is a correlation, then associating a product object specified with parent content with the child content.

11. The process of claim 10, further comprising the steps of:
registering the child content with product information from the corresponding product object associated with the parent content; and
recording a parent-child content relationship.

12. A process for tracking activities based on content registration, comprising the steps of:
obtaining content;
establishing a parent-child content relationship from information associated with the content;
tracking parent-child content relationships; and
establishing an activity based upon a parent-child content relationship.

13. The process of claim 12, further comprising the step of tracking the established activities.

14. A process for chain reaction marketing and sales, the process comprising the steps of:
(a) obtaining content (parent content) with product(s) or product object(s) associated therewith;
(b) obtaining or creating additional content (child content); and
(c) verifying if an object in the child content correlates with an object in the parent content or a product object specified in the parent content and if there is a correlation, then associating the product(s) or product object(s) associated with the parent content with the child content.

15. The process of claim 14, further comprising the step of registering the comments as child content of the parent content with an associated commenter.

16. The process of claim 15, further comprising the step of associating the child content with the parent content.

17. A chain hanger structure for use in a computer-based online system for conducting marketing and commerce, comprising:
an Identification Information Holder or Pointer;
a Parent-Child Relation Information Holder or Pointer;
a Content Registration Information Holder or Pointer;
a Product Registration Information Holder or Pointer; and
a Supplementary Information Holder or Pointer.

18. A method of implementing the chain hanger structure of claim 20, comprising the steps of:
providing a list of content properties; and
providing a set of product objects,
wherein the chain hanger structure is configured to organize product objects with content and associate content, products, content authors, content and product registers, content registration, and product registration with one another, and track content parent-child relationships.

19. The method of claim 18, wherein the list of content properties includes:
a set of Content Source IDS, which holds information related to or provides at least one pointer pointing to at least one source content;
a set of Parent Content IDS, which holds information related to or provides at least one pointer pointing to at least one parent content;
a set of Originators, which holds information related to or provides at least one pointer pointing to at least one originator of the content; and
a set of Product Objects, which holds information related to or provides at least one pointer pointing to at least one identification of Product Object.

20. The method of claim 19, wherein the set of product objects includes:
a set of Product Registers, which holds information related to or provides at least one pointer pointing to at least one product register;
a Residential Information, which holds information related to or provides a pointer pointing to information that recovers indication of product objects in a content when the content is displayed again;
a Product ID, which holds information related to or provides a pointer pointing to a product registration information; and
a Product Object ID, which holds information related to or provides pointer pointing to its identification of the product object,
wherein the Product Object ID is pointed or indexed by an element of Product Objects in a list of content properties.

21. A method of product registration in an online system for marketing and commerce, comprising the steps of:
(a) creating content or obtaining content from a source;
(b) specifying an object in the content;
(c) specifying a product and associating the product with the object to form a product object;
(d) registering the associated product; and
(e) determining if the product object specified was previously registered and if not, obtaining an empty product object from a set of product objects of a chain hanger and assigning a unique product object ID and including the product object ID in the product objects of a list of content properties of the chain hanger.

22. The method of claim 21, further comprising the steps of:
(f) determining if the product object specified was previously registered and if so, assigning information or updating the chain hanger;
(g) validating and verifying product credibility; and
(h) updating product related information in the system.

23. The method of claim 21, further comprising the step of establishing at least one pointer to or at least one holder containing information relating to at least one element, the at least one element selected from content, user, object, or other data and information or combinations thereof, the step of establishing at least one pointer or at least one holder conducted prior to the step of registering the associated product.

24. A method of registering content with one or more products in an online system for marketing and commerce, comprising the steps of:
(a) creating content or obtaining content from a source;
(b) specifying an object in the content;
(c) specifying a product and associating the product with the object;
(d) registering the content with the associated product; and
(e) determining whether the content was previously registered in the system, the determining comprising:
(i) if the content was not previously registered, creating a new chain hanger that is associated with the user and the content and generating a unique content source IDS;
(ii) if the content was previously registered, retrieving existing and corresponding chain hangers using user information and content information; and
(iii) for newly created content having parent content, assigning the content source IDS of the parent content to a parent content IDS of the chain hanger for newly created content having parent content, or assigning a value of NULL to the parent content IDS of the chain hanger should no parent content exist; and
(f) recording the authors of the content as originators of the chain hanger.

25. The method of claim 24, wherein the unique content source IDS is generated so as to point to the original content at an original location of the original content, and create a replicated copy of the content.

26. A method for chain reaction marketing and sales, the method comprising the steps of:
(a) obtaining content (parent content) containing registered product objects and a chain hanger;
(b) retrieving a content source IDS from the chain hanger of the parent content;
(c) providing and associating comments with the parent content;
(d) verifying if an object in the comment correlates an object in the parent content or a product object in the parent content and if there is a correlation, then creating a new chain hanger and relating the new chain hanger to a commenter and the comments; and
(e) updating a list of content properties of the new chain hanger.

27. The process of claim 26, further comprising the steps of:
correlating a set of product objects from the parent content and associating the correlated product objects in the comments;
obtaining an empty product object list from the set of product objects of the new chain hanger; and
updating elements in the product object list and the new chain hanger,
wherein the content source IDS serves as a parent content IDS of the new chain hanger of the comments.

28. A process for conducting online commerce, the process comprising the steps of:
(a) obtaining content having associated therewith registered product objects;
(b) specifying a product object from the content that contains a product that a user wants to purchase;
(c) processing information about the user, the content, the product object, and other data and information;
(d) retrieving product purchasing information; and
(e) completing a purchase transaction.

29. The process of claim 28, further comprising the step of:
(f) recording all accountability information for tracking, post activities, and reporting.

30. A method for conducting chain reaction marketing and commerce, the method comprising:
(a) registering content;
(b) registering a product;
(c) conducting chain reaction marketing; and
(d) conducting online commerce,
wherein the step of conducting the online commerce includes:
(i) obtaining content having associated therewith registered product objects;
(ii) specifying a product object from the content that contains a product that a user wants to purchase;
(iii) processing information about the user, the content, the product object, and other data and information;
(iv) retrieving product purchasing information; and
(v) completing a purchase transaction.

31. The method of claim 30, wherein the step of registering the content further comprises:
(i) creating the content or obtaining the content from a source;
(ii) specifying an object in the content;
(iii) determining whether the content was previously registered in the system;
(iv) if the content was not previously registered, creating a new chain hanger that is related to the user and the content and generating a unique content source IDS;
(v) if the content was previously registered, retrieving existing and corresponding chain hangers using user information and content information;
(vi) for newly created content having parent content, assigning the content source IDS of the parent content to a parent content IDS of the chain hanger for newly created content having parent content, or assigning a value of NULL to the parent content IDS of the chain hanger should no parent content exist; and
(vii) recording authors of the content as originators of the chain hanger.

32. The method of claim 31, wherein the step of registering the product further comprises (i) determining if the product object specified was previously registered and if not, an empty product object list is obtained from a set of product objects of the chain hanger and a unique product object ID is assigned and the product object ID is included in the product objects of a list of content properties of the chain hanger.

33. The method of claim 32, wherein the step of registering the product further comprises (ii) determining if the product object specified was previously registered and if so, information is assigned or updated in the chain hanger.

34. The method of claim 30, wherein the step of conducting the chain reaction marketing further comprises:
(i) obtaining content having associated therewith registered product objects and a chain hanger;
(ii) retrieving a content source IDS from the chain hanger of the content;
(iii) providing and associating comments with the content;
(iv) verifying if an object in the comment correlates an object in the parent content or a product object in the parent content's chain hanger and if there is a correlation, then a new chain hanger is created and related to a commenter and the comments; and
(v) updating a list of content properties of the new chain hanger.

35. The method of claim 34, wherein the step of conducting the chain reaction marketing further comprises correlating a set of product objects from the parent chain hanger and associating the matched product objects in the comments.

34. The method of claim 35, wherein the step of conducting the chain reaction marketing further comprises obtaining an empty product object list from the set of product objects of the new chain hanger.

35. The method of claim 34, wherein the step of conducting the chain reaction marketing further comprises updating all elements in the product object list and the new chain hanger.

36. A computer-based online system for conducting chain reaction marketing and commerce, the system comprising:
(a) a central control repository configured to manage system information, the central control repository operatively connected to a plurality of system tools, including a tool for product registration, a tool for providing comments, and a tool for conducting commerce;
(b) a content repository configured to store and manage system content, the content repository operatively connected to the tool for product registration and the tool for providing comments;
(c) a user repository configured to store and manage user information, the user repository operatively connected to the tool for product registration and the tool for providing comments;
(d) a product repository configured to store and manage product information, the product repository operatively connected to the tool for product registration and the tool for conducting commerce; and
(e) a commerce repository configured to store and manage commercial information, the commerce repository operatively connected to the tool for conducting commerce.

37. The system of claim 36, wherein the central control repository implements chain hangers.

38. The system of claim 37, wherein each of the chain hangers includes a list of content properties and a set of product objects.

39. The system of claim 38, wherein each of the chain hangers organizes product objects with content and associates content, products, content authors, and product registers together.

40. The system of claim 39, further comprising a content heritage tree configured to manage a plurality of chain hangers in a layered format, the content heritage tree configured to establish post-activities.

41. A computer system for conducting chain reaction marketing and commerce, the system comprising:
a CPU, a computer readable memory, and a computer readable storage media;
first program instructions to register content;
second program instructions to register a product;
third program instructions to conduct chain reaction marketing; and
fourth program instructions to conduct online commerce,
wherein the fourth program instructions to conduct online commerce includes:
(i) obtaining content having associated therewith registered product objects and a chain hanger;
(ii) specifying a product object from the content that contains a product that a user wants to purchase;
(iii) processing information about the user, the content, the product object, and other data and information;
(iv) retrieving product purchasing information; and
(v) completing a purchase transaction,
wherein the first through fourth program instructions are stored on the computer readable storage media for execution by the CPU via the computer readable memory.

42. The computer system of claim 41, wherein the first program instructions to register the content comprises:
(i) creating the content or obtaining the content from a source of content;
(ii) specifying an object in the content;
(iii) determining whether the content was previously registered in the system;
(iv) if the content was not previously registered, creating a new chain hanger that is related to the user and the content and generating a unique content source IDS;
(v) if the content was previously registered, retrieving existing and corresponding chain hangers using user information and content information;
(vi) for newly created content having parent content, assigning the content source IDS of the parent content to a parent content IDS of the chain hanger for newly created content having parent content, or assigning a value of NULL to the parent content IDS of the chain hanger should no parent content exist; and
(vii) recording authors of the content as originators of the chain hanger.

43. The computer system of claim 42, wherein the second program instructions to register the product comprises (i) determining if the product object specified was previously registered and if not, an empty product object list is obtained from a set of product objects of the chain hanger and a unique product object ID is assigned and the product object ID is included in the product objects of a list of content properties of the chain hanger.

44. The computer system of claim 43, wherein the step of registering the product further comprises (ii) determining if the product object specified was previously registered and if so, information is assigned or updated in the chain hanger.

45. The computer system of claim 41, wherein the third program instructions to conduct the chain reaction marketing comprises:
(i) obtaining content having associated therewith registered product objects and a chain hanger;
(ii) retrieving a content source IDS from the chain hanger of the content;
(iii) providing and associating comments with the content;
(iv) verifying if an object in the comment correlates an object in the parent content or a product object in the parent content's chain hanger and if there is a match, then a new chain hanger is created and related to a commenter and the comments; and
(v) updating a list of content properties of the new chain hanger.

46. The computer system of claim 45, wherein the third program instructions to conduct the chain reaction marketing further comprises correlating a set of product objects from the parent chain hanger and associating the matched product objects in the comments.

47. The computer system of claim 46, wherein the third program instructions to conduct the chain reaction marketing further comprises obtaining an empty product object list from the set of product objects of the new chain hanger.

48. The computer system of claim 47, wherein the third program instructions to conduct the chain reaction marketing further comprises updating all elements in the product object list and the new chain hanger.

49. A computer program product comprising a computer readable storage medium having readable program code embodied in the storage medium, the computer program product includes at least one component operable to:
create content or obtain content from a source;
specify an object in the content;
specify a product and associating the product with the object to form a product object; and
register the associated product.

50. The computer program product of claim 49, further comprising at least one component operable to establish at least one pointer to or at least one holder containing information relating to at least one element, the at least one element selected from content, user, object, or other data and information or combinations thereof.

51. A method implemented in a computer infrastructure comprising a combination of hardware and software, the method comprising:
creating content or obtaining content from a source of content;
specifying an object in the content;
specifying a product and associating the product with the object to form a product object; and
registering the associated product.

52. The method of claim 51, wherein a service provider at least one of creates, maintains, deploys and supports the computer infrastructure.

53. The method of claim 52, wherein the steps of claim 51 are provided by a service provider on a subscription, advertising, and/or fee basis.

54. The method of claim 53, further comprising the step of establishing at least one pointer to or at least one holder containing information relating to at least one element, the at least one element selected from content, user, object, or other data and information or combinations thereof, the step of establishing at least one pointer or at least one holder conducted prior to the step of registering the associated product.
